(19) United States
(12) Patent Application Publication
(10) Pub. No.: US 2015/0253700 A1
(43) Pub. Date: Sep. 10, 2015

(54) IMAGE HEATING APPARATUS

(71) Applicant: CANON KABUSHIKI KAISHA, Tokyo (JP)

(72) Inventor: Kazunari Hatazaki, Nagareyama-shi (JP)

(21) Appl. No.: 14/632,330

(22) Filed: Feb. 26, 2015

(30) Foreign Application Priority Data
Mar. 10, 2014 (JP) 2014-045861

(51) Int. Cl. G03G 15/20

(52) U.S. Cl. CPC G03G 15/2025; G03G 15/2039

(57) ABSTRACT

An image heating apparatus includes: a heating member; a collecting member; a cleaning web; an urging roller; a moving mechanism configured to move the urging roller between a first position where the cleaning web contacts the collecting member, a second position where the cleaning web contacts the collecting member at a contact pressure lower than a contact pressure at the first position, and a third position where the cleaning web is spaced from the collecting member; an executing portion configured to execute a collecting member cleaning operation at the second position and the first position in this order; and a controller configured to control a temperature of the collecting roller so that the temperature when the urging roller is moved from the third position to the second position is higher than the temperature when the urging roller is moved from the second position to the first position.

### FIELD OF THE INVENTION AND RELATED ART

The present invention relates to an image heating apparatus. This image heating apparatus is used in an image forming apparatus such as a copying machine, a printer, a facsimile machine and a multi-function machine having a plurality of functions of these machines.

In a conventional image forming apparatus of an electrophotographic type, a toner image formed on a recording material is fixed by a fixing device (image heating apparatus).

In such a fixing device, e.g., in the case where a jam generates, there is a liability that a toner is offset in a large amount on a fixing roller (rotatable heating member), and therefore a mechanism for cleaning the fixing roller is provided (Japanese Laid-Open Patent Application (JP-A) Hei 6-194986). Specifically, a constitution in which the fixing roller is cleaned using a cleaning web is employed.

Further, there is a liability that the fixing roller is damaged by a foreign matter sandwiched between the fixing roller and the web, and therefore a constitution in which a collecting roller is interposed between the fixing roller and the web has been proposed (JP-A 2004-212409). Specifically, the offset toner is once collected from the fixing roller onto the collecting roller, and then the collected offset toner is cleaned with the web is employed.

However, in the case where the toner is offset in a large amount on the fixing roller with generation of the jam, in order to early resume image formation, the offset toner in the large amount is required to be removed in a short time.

### SUMMARY OF THE INVENTION

According to an aspect of the present invention, there is provided an image heating apparatus comprising: a rotatable heating member configured to heat a toner image on a recording material; a rotatable collecting member configured to collect a toner deposited on the rotatable heating member; a cleaning web configured to clean the rotatable collecting member; an urging roller configured to urge the cleaning web toward the rotatable collecting member; a moving mechanism configured to move the urging roller so as to be movable between a first position where the cleaning web contacts the rotatable collecting member, a second position where the cleaning web contacts the rotatable collecting member at a contact pressure lower than a contact pressure at the first position, and a third position where the cleaning web is spaced from the rotatable collecting member; an executing portion configured to execute an operation in a cleaning mode in which the rotatable collecting member is cleaned at the second position and the first position in this order; and a controller configured to control a temperature of the rotatable collecting roller so that the temperature when the urging roller is moved from the third position to the second position is higher than the temperature when the urging roller is moved from the second position to the first position.

According to another aspect of the present invention, there is provided an image heating apparatus comprising: a rotatable heating member configured to heat a toner image on a recording material; a rotatable collecting member configured to collect a toner deposited on the rotatable heating member; a cleaning web configured to clean the rotatable collecting member; an urging roller configured to urge the cleaning web toward the rotatable collecting member; a moving mechanism configured to move the urging roller so as to be movable between a first position where the cleaning web contacts the rotatable collecting member, a second position where the cleaning web contacts the rotatable collecting member at a contact pressure lower than a contact pressure at the first position, and a third position where the cleaning web is spaced from the rotatable collecting member; an executing portion configured to execute an operation in a cleaning mode in which the rotatable collecting member is cleaned at the second position and the first position in this order; and a controller configured to control a temperature of the rotatable collecting roller in the operation in the cleaning mode, wherein in the operation in the cleaning mode, the moving mechanism moves the urging roller from the third position to the second position when the temperature is a first temperature, and moves the urging roller from the second position to the first position when the temperature is a second temperature lower than the first temperature.

According to a further aspect of the present invention, there is provided an image heating apparatus comprising: a rotatable heating member configured to heat a toner image on a recording material; a rotatable collecting member configured to collect a toner deposited on the rotatable heating member; a cleaning web configured to clean the rotatable collecting member; an urging roller configured to urge the cleaning web toward the rotatable collecting member; a moving mechanism configured to move the urging roller so as to be movable between a first position where the cleaning web contacts the rotatable collecting member, a second position where the cleaning web contacts the rotatable collecting member at a contact pressure lower than a contact pressure at the first position, and a third position where the cleaning web is spaced from the rotatable collecting member; an executing portion configured to execute an operation in a cleaning mode in which the rotatable collecting member is cleaned at the second position and the first position in this order; and a controller configured to move the cleaning web from the first position to the third position with generation of a jam and configured to start a cleaning process after jam clearance by moving the cleaning web from the third position to the second position when a temperature of the rotatable collecting member is not less than a predetermined temperature.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of an image forming apparatus.

FIG. 2 is a sectional view showing a structure of a fixing device.

FIG. 3 is a schematic view showing a contact-and-separation mechanism for moving a web roller toward and away from a collecting roller.

In FIG. 4, (a) to (c) are schematic views each showing a state of the contact-and-separation means for the collecting roller and the web roller at a position.

FIG. 5 is a block diagram showing a control system.

FIG. 6 is a flowchart relating to a cleaning process.

FIG. 7 is a sectional view for illustrating a modified embodiment.

### DESCRIPTION OF THE EMBODIMENTS

Embodiments of the present invention will be described with reference to the drawings. In the following embodiments, a constitution in which an image heating apparatus is used as a fixing device for fixing an unfixed toner image on a sheet (recording material) will be described, but the present invention can also be carried out as a heat treatment device for adjusting an image surface property by heating the recording material on which a fixed image or a partly fixed image is carried.

Incidentally, dimensions, materials and shapes of constituent elements and their relative arrangements and the like described in the following embodiments should be changed appropriately depending on structures and various conditions of apparatuses (devices) to which the present invention is applied, and the present invention is not intended to be limited to the following embodiments.

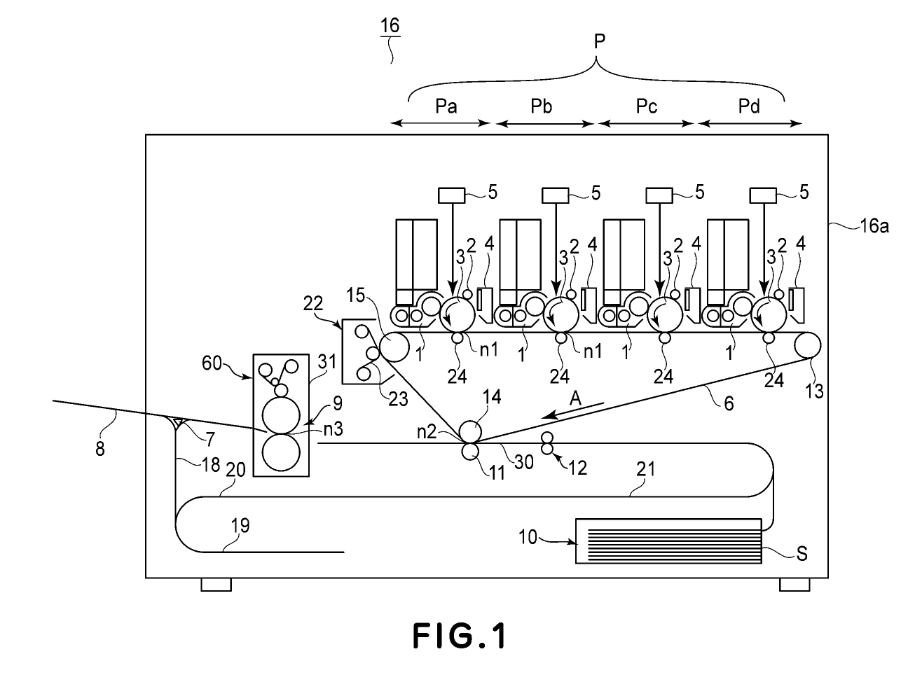

First, a color electrophotographic printer as an image forming apparatus according to the present invention will be described with reference to FIG. 1. FIG. 1 shows the color electrophotographic printer in a state of a cross section along a feeding direction of the sheet. In the following embodiments, the color electrophotographic printer is simply referred to as a printer.

### [Printer]

As shown in Embodiment 1, a printer 16 includes a printer main assembly 16a provided with image forming portions Pa, Pb, Pc and Pd corresponding to colors of Y (yellow), M (magenta), C (cyan) and Bk (black), respectively. The image forming portions Pa, Pb, Pc and Pd are different in colors of toners used as Y, M, C and Bk, respectively, but the same structure is employed. For this reason, these image forming portions will be described as a common image forming portion P.

The image forming portion P includes an electrophotographic photosensitive drum 3 and members, including a charger 2, a laser scanner 5, a developing device 1, a primary transfer roller 24 and a drum cleaner 4, which are provided in the listed order along a rotational direction of the photosensitive drum 3.

In each image forming portion P, the photosensitive drum 3 is electrically charged by the charger in advance, and thereafter an electrostatic latent image is formed by the laser scanner 5. In the laser scanner 5, unshown light source device and polygon mirror are provided. Laser light emitted from the light source device is used to scan the surface of the photosensitive drum 3 with the polygon mirror, and light fluxes of the scanning light is deflected by a reflection mirror and are focused on a generatrix of the photosensitive drum 3 by an unshown fθ lens to expose the photosensitive drum surface, so that the electrostatic latent image depending on an image signal is formed on the photosensitive drum 3.

Then, the electrostatic latent image is visualized as a toner image by the developing device 1. That is, in the developing device 1, as a developer, a toner of a corresponding color is filled in a predetermined amount by an unshown supplying device. Each developing device 1 develops the electrostatic latent image on the corresponding photosensitive drum 3, and thus visualizes the electrostatic latent image as the toner image of the corresponding color.

The toner used in this embodiment contains (incorporates), a wax consisting of paraffin or polyolefin, or a silicone oil as a parting agent. Specifically, in this embodiment, a toner obtained by finely dispersing a wax component and a pigment into a pulverized toner is used. A constitution in which a polymerization toner containing such a wax component is used may also be employed. In the following description, as the parting agent, the wax is described as an example, but as described above, also the case where the silicone oil is used as the parting agent is similarly applied.

The toner images, corresponding to the associated colors, formed on the respective photosensitive drums 3 are successively primary-transferred onto an intermediary transfer belt 6 as an image bearing member by primary transfer rollers 24. That is, in a process in which the toner image formed and carried on the associated photosensitive drum 3 passes through a primary transfer nip n1 between the photosensitive drum 3 and the intermediary transfer belt 6, the toner image is intermediately transferred onto an outer peripheral surface of the intermediary transfer belt 6 by pressure and an electric field formed by a primary transfer bias applied to the intermediary transfer belt 6. After this primary transfer, a transfer residual toner remaining on the photosensitive drum 3 is removed by cleaning with the drum cleaner 4, and therefore the surface of the photosensitive drum 3 is cleaned and can prepare for subsequent image formation.

On the other hand, a recording material S is fed one by one from a sheet feeding cassette 10 and then is sent into a registration roller pair 12. The registration roller pair 12 once receives the recording material S and corrects oblique movement of the recording material S. Then, the registration roller pair 12 sends the recording material to a secondary transfer nip n2 between the intermediary transfer belt 6 and a secondary transfer roller 11 in synchronism with the toner image on the intermediary transfer belt 6. The intermediary transfer belt 6 is constituted so that the intermediary transfer belt 6 is rotatable at the same peripheral speed as those of the photosensitive drums 3 in an arrow A direction by stretching rollers 13, 14 and 15.

The color toner images on the intermediary transfer belt 6 are secondary-transferred onto the recording material S at the secondary transfer nip n2 by the secondary transfer roller 11. The secondary transfer roller 11 is shaft-supported in parallel with the intermediary transfer belt 6 correspondingly to the intermediary transfer belt 6, and is supported in a state in which the secondary transfer roller 11 contacts a lower surface of the intermediary transfer belt 6. To the secondary transfer roller 11, a desired secondary transfer bias is applied by a secondary transfer bias (voltage) source (not shown). The secondary transfer, onto the recording material S, of the four color toner images superposedly transferred as a synthetic color toner image is carried out in the following manner. That is, the recording material S fed from the sheet feeding cassette 10 passes through the registration roller pair 12 and a pre-transfer guide 30 and then is fed to the secondary transfer nip n2 at predetermined timing, and at the same time, the secondary transfer bias is applied from the bias (power) source to the secondary transfer roller 11, whereby the secondary transfer is carried out.

By this secondary transfer bias, the synthetic color toner image is secondary-transferred from the intermediary transfer belt 6 onto the recording material S. The synthetic color toner image is formed on the recording material S while leaving a certain in margin from each of four edges of the recording material S. In this embodiment, a leading end portion margin is about 2-3 mm. A transfer residual toner and another foreign matter are wiped off by rubbing the surface of the intermediary transfer belt 6 with a cleaning web 23 consisting of a nonwoven fabric in a belt cleaner 22.

Then, the recording material S on which the toner images are secondary-transferred is introduced successively into a heating nip n3 of the fixing device 9, so that the toner images on the recording material (sheet) S is fixed by being heated and pressed at the heating nip n3. As a specific example of the recording material S on which the toner image is to be formed, it is possible to use plain paper, a resin-made sheet material as an alternative to the plain paper, thick paper, a recording material for an overhead projector, and the like.

In the case where the toner image is formed on one surface of the recording material S, depending on a condition, a feeding path is switched by a switching member (flapper) 7. On the other hand, in the case where the toner image is formed on double (both) surfaces of the recording material S, the recording material S on which the toner image is fixed by the fixing device 9 is guided onto a discharge tray 8 by the switched switching member 7. Then, when a trailing end of the recording material S reaches a reversing point, the recording material S is fed along switch-back feeding paths 18, 19 and 20 in a switch-back manner, and is turned upside down. Thereafter, the recording material S is fed along a feeding path 21 for double-side printing, and then is subjected to the same process as that during one-side image formation (printing), so that the toner image is formed on the other (back) surface, and then is discharged on the discharge tray 8.

Incidentally, in the case of a printer having a monochromatic (Bk single color) structure, only the photosensitive drum 3 for black in the above-described exists, and the toner image formed on the photosensitive drum 3 is constituted s as to be transferred onto the recording material by the transfer device.

The fixing device 9 in this embodiment has a constitution in which the toner image formed on the recording material S by using the toner containing the parting agent is fixed on the recording material S by being heated and pressed. The constitution will be specifically described.

### [Fixing Device]

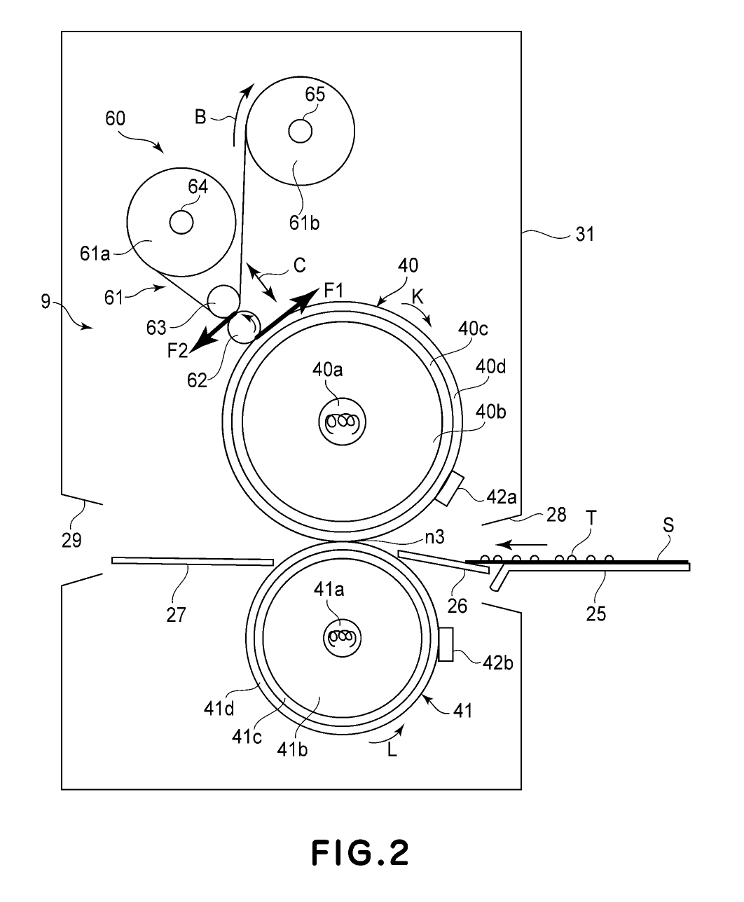

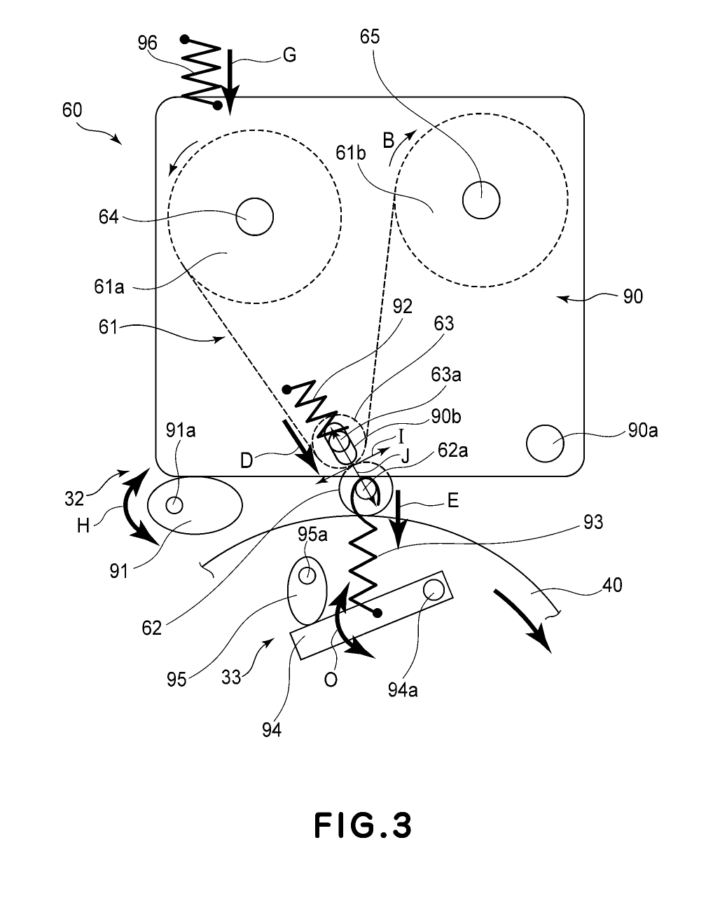

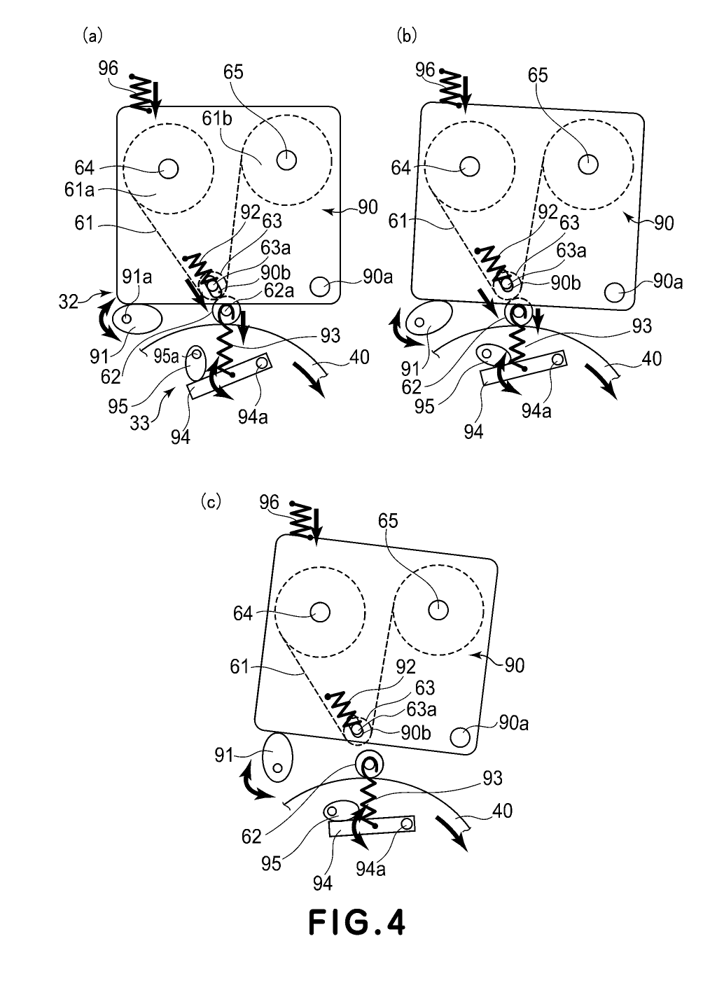

Next, the fixing device 9 as the image heating apparatus will be described with reference to FIGS. 2 to 4. FIG. 2 is a sectional view showing a structure of the fixing device 9 in this embodiment, FIG. 3 is a schematic view showing a contact-and-separation mechanism 32 for moving a web roller 63 toward and away from a collecting roller 62, and (a) to (c) of FIG. 4 are schematic views each showing a state of the contact-and-separation mechanism 32 at a position.

As shown in FIG. 2, inside a casing 31 supported in the printer main assembly 16a, the fixing device 9 including a cleaning unit 60 provided at an upper portion is disposed. In the fixing device 9, an opposite roller 41 as a rotatable opposite member is press-contacted to a fixing roller 40 as a rotatable heating member, for heating the recording material, at a total pressure of, e.g., about 784 (N) (about 80 (kg)), so that the heating nip n3 of the recording material S is formed.

In this way, the opposite roller (rotatable opposite member) 41 is contacted to the fixing roller (rotatable heating member) 40, so that the heating nip n3 for heating the image (toner image) on the recording material S. In the fixing device 9, the (unfixed) toner image T secondary-transferred on the recording material S is nipped and fed in the heating nip n3 between the fixing roller 40, to be contacted to the image surface, and the opposite roller 41, and thus is fixed on the recording material S. Referring to FIG. 2, in front of the develop 9, pre-fixing guides 25 and 26 are provided, and behind the fixing device 9, a post-fixing guide 27 is provided. Further, the recording material S is fed into the fixing device 9 through an entrance opening 28 and comes out of the fixing device 9 through an exit opening 29.

The fixing roller 40 is constituted as a cylindrical shape having, e.g., a diameter of 60 mm by disposing, e.g., a 3 mm-thick elastic layer 40c on an outer peripheral surface of an aluminum cylindrical core metal 40b. A lower layer of the elastic layer 40c is a HTV (high-temperature vulcanizing) silicone rubber layer, and on an outer peripheral surface of the HTV silicone rubber layer, an RTV (room-temperature vulcanizing) silicone rubber layer as a heat-resistant elastic layer 40d to be contacted to the image surface is disposed.

On the elastic layer 40c, in order to improve a parting property with the toner, a fluorine-containing resin material (PFA tube in this embodiment) as a heat-resistant parting layer 40d is coated. Further, at a center portion of the core metal 40b of the fixing roller 40 a fixing roller heater 40a consisting of a halogen heater, having predetermined rated electric power, for heating the fixing roller 40 from an inside so that a surface temperature of the fixing roller 40 becomes a predetermined temperature is provided non-rotatably. This fixing roller heater 40a functions as a heating mechanism for heating the fixing roller 40 and also has the function of heating the collecting roller 62 as a rotatable collecting member.

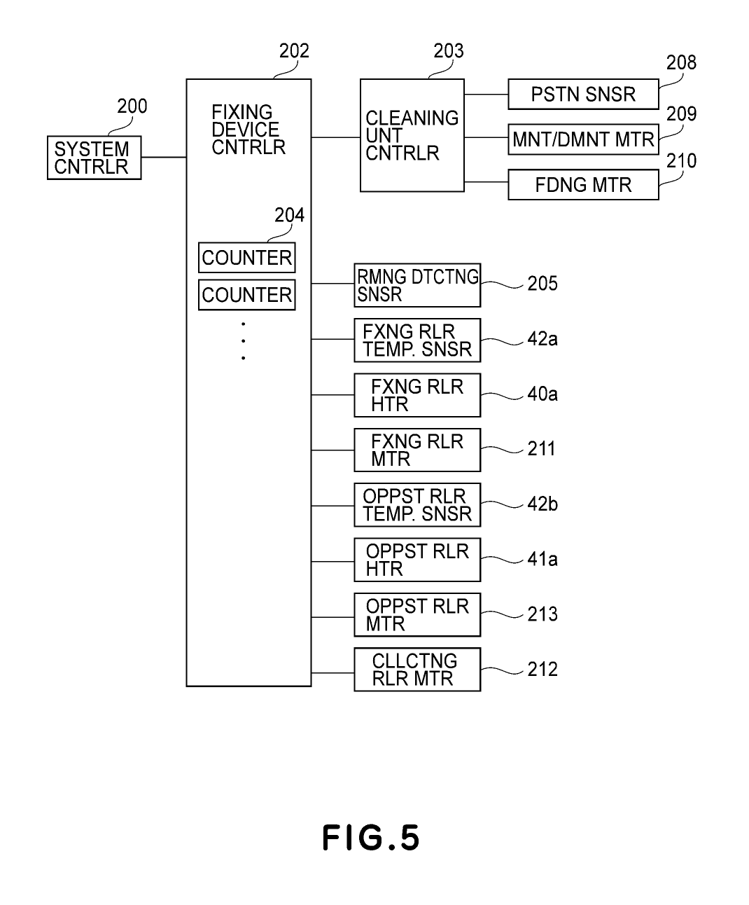

The fixing roller heater 40a is a heating source for heating the surface of the fixing roller (rotatable member) 40 up to a set temperature, and the set temperature is charged by control thereof by a controller 202 (FIG. 5). The controller 202 also functions as an executing portion. That is, the controller 202 controls an operation of the fixing roller heater 40a on the basis of an output of a temperature sensor (detecting device) 42a.

On the other hand, the opposite roller 41 disposed so as to oppose the fixing roller 40 is constituted as a cylindrical shape having, e.g., a diameter of 60 mm by disposing, e.g., a 1 mm-thick elastic layer 41c on an outer peripheral surface of an aluminum cylindrical core metal 41b. A lower layer of the elastic layer 41c is a HTV silicone rubber layer, and on an outer peripheral surface of the HTV silicone rubber layer, a fluorine-containing resin layer is disposed.

On the elastic layer 41c, in order to improve a parting property with the toner, a heat-resistant parting layer 41d is coated. Further, at a center portion of the core metal 41b of the opposite roller 41, an opposite roller heater 41a having predetermined rated electric power, for heating the opposite roller 41 from an inside so that a surface temperature of the opposite roller 41 becomes a predetermined temperature is provided non-rotatably.

In this embodiment, by combining the fixing roller 40 and the opposite roller 41 each having the above-described layer structure, the parting property against a sharp-melt toner is further improved. Further, in order to fix double-side images, not only at the surface of the fixing roller 40 but also at the surface of the opposite roller 41, the above-described parting layer (40d or 41d) of RTV or LTV (low-temperature vulcanizing) silicone rubber or the like having a high toner parting effect is provided.

Each of the fixing roller 40 and the opposite roller 41 is rotatably supported at end portions thereof by ball bearings (not shown). Each of the fixing roller 40 and the collecting roller 41 is provided with a gear (not shown) at one of shaft end portions thereof, and these gears of the rollers 40 and 41 are connected with each other by a gear mechanism (not shown), so that the rollers 40 and 41 are rotationally driven integrally by an unshown driving mechanism in arrow K and L directions, respectively.

In the casing 31, a temperature sensor (detecting device) 42a such as a thermistor is provided so as to detect a surface temperature of the fixing roller 40 in contact with the surface of the fixing roller 40. The temperature sensor 42a is disposed upstream of the heating nip n3 with respect to the rotational direction of the fixing roller 40. The temperature sensor 42a is connected with a controller 202 (FIG. 5). The temperature sensor 42a constitutes a detecting mechanism for detecting the temperature of the fixing roller (rotatable heating member) 40. The controller 202 adjusts electric power supplied to the fixing roller heater 40a so that the surface temperature of the fixing roller 40 detected by the temperature sensor 42a converges to a predetermined (e.g., about 165° C.).

In the casing 31, an opposite roller temperature detecting sensor 42b such as a thermistor is provided so as to detect a surface temperature of the opposite roller 41 in contact with the surface of the opposite roller 41. The opposite roller temperature detecting sensor 42b is disposed upstream of the heating nip n3 with respect to the rotational direction of the opposite roller 41. The opposite roller temperature detecting sensor 42b is connected with the controller 202 (FIG. 5). The controller 202 adjusts electric power supplied to the opposite roller heater 41a so that the surface temperature of the opposite roller 41 detected by the opposite temperature detecting sensor 42b converges to a predetermined (e.g., about 140° C.).

### [Cleaning Unit]

As shown in FIGS. 2 and 3, the cleaning unit 60 for cleaning the fixing roller 40 includes the collecting roller 62 as the rotatable collecting member (rotatable cleaning member) formed of stainless steel (SUS 303) in an outer diameter of, e.g., 20 (mm). This collecting roller 62 is constituted so as to be rotated by rotation of the fixing roller 40. The collecting roller 62 collects the toner from the fixing roller (rotatable member) 40. Further, the cleaning unit 60 includes a cleaning web 61 formed with a nonwoven fabric. The web (cleaning sheet) 61 slides with the collecting roller 62, and removes the toner collected by the collecting roller 62.

The collecting roller 62 is rotatably supported by a rotation shaft 62a supported at end portions by the casing 31, and is also constituted so that pressure to be applied to the fixing roller (rotatable member) 40 is capable of being switched by a pressure switching mechanism 33 as a pressure switching means. The pressure switching mechanism 33 is constituted by a collecting roller urging cam 95, a collecting roller urging arm 94 and a collecting roller urging spring 93 which are described later.

In the case where the toner is peeled off from the recording material S and is deposited as an offset toner (residual toner) on the fixing roller 40, the collecting roller 62 cleans the fixing roller 40 and collects the offset toner from the fixing roller 40. The collecting roller 62 is always contacted to the fixing roller 40 for the purpose of collecting a deposited matter such as a foreign matter on the surface of the fixing roller 40 also in a period other than during the image formation.

In this embodiment, a constitution in which the collecting roller 62 is contacted to the fixing roller 40 as the rotatable member to clean the surface of the fixing roller 40 is employed. However, the present invention is not limited thereto, and a constitution in which the collecting roller 62 is contacted to the opposite roller 41 to clean the surface of the opposite roller 41 may also be employed. In this case, the opposite roller 41 constitutes the rotatable member in the present invention, and the opposite roller heater 41a of the opposite roller 41 constitutes the heating source for heating the surface of the opposite roller 41 (rotatable member) up to the set temperature. The set temperature for the opposite roller 41 is changed by control by the controller 202. Also by employing such a constitution, an effect similar to that in the case where the collecting roller 62 is contacted to the fixing roller 40 can be obtained. Such a constitution is also applicable to a modified embodiment described later.

The cleaning unit 60 includes a feeding (sending) roller 64 about which a feeding end portion 61a of the web 61 is wound and a winding-up roller 65 for winding up a winding end portion 61b of the web 61 fed from the feeding roller 64. Further, the cleaning unit 60 includes a web roller as an urging (pressing) roller for pressing the cleaning web 61 against the collecting roller 62. The pressure of the web roller 63 applied to the collecting roller 62 is switched by the contact-and-separation mechanism (moving mechanism) 32. The contact-and-separation mechanism 32 is constituted by a roller supporting plate 90, an elongated hole 90b formed in the plate 90, a mounting-and-demounting cam 91, a web roller urging spring 92 consisting of a compression spring, and a unit urging spring 96 consisting of a compression spring, which are described later.

The contact-and-separation mechanism 32 moves the cleaning unit 60 (web roller 63) so that the web roller 63 can move roller a first position (position shown in (a) of FIG. 4), a second position (position shown in (b) of FIG. 4) and a third position (position in (c) of FIG. 4). The first position is, as shown in (a) of FIG. 4, the position where the web 61 contacts the collecting roller 62. The second position is, as shown in (b) of FIG. 4, the position where the web 61 contacts the collecting roller 62 at a contact pressure lower than a contact pressure at the first position. The third position is, as shown in (c) of FIG. 4, the position where the web 61 is spaced from the collecting roller 62.

In the casing 31 in FIG. 2, the roller supporting plate 90 shown in FIG. 3 is disposed in each of front and rear sides of FIG. 2 correspondingly to associated ones of end portions of the rollers 63, 64 and 65 of the cleaning unit 60. By the roller supporting plates 90 and 90 disposed in the front and rear sides, each of the web roller 63, the feeding roller 64 and the winding-up roller 65 is supported at end portions thereof. The roller supporting plates 90 are supported so as to be rotatable about the unit rotation shaft 90a as a fulcrum in the clockwise direction and the counterclockwise direction in FIG. 3.

The end portions of the cleaning web 61 is rotatably supported by the feeding roller 63 and the winding-up roller 65, and a web feeding motor 210 (FIG. 5) for winding up the cleaning web 61 is connected with the cleaning web 61. When the web feeding motor rotates in a winding-up direction, the winding-up end portion 61b is wound up by the winding-up roller 65, whereby the web 61 advances in an arrow D direction to pass through the web roller 63. Then, the feeding end portion 61a is pulled, whereby the feeding roller 64 is rotated. As a result, the cleaning web 61 is gradually wound up in an arrow B direction.

The web roller 63 is provided so that a rotation shaft 63a formed of high-rigidity metal (SUS 303) penetrates through a center of the web roller 63 in order to suppress flexure (bending) when the web 61 is pressed against the collecting roller 62 by the web roller 63. Each of the roller supporting plates 90 provided in the front and rear sides is provided with the elongated hole 90b formed at a position opposing the collecting roller 62 contacting an upper portion of the fixing roller 40. Into these elongated holes 90b, end portions of the rotation shaft 63a are inserted slidably, respectively. The end portions of the rotation shaft 63a of the web roller 63 are urged toward the collecting roller 62 by the web roller urging springs 92 supported at one ends by the roller supporting plates 90 provided in the front and rear sides.

The web roller 63 may preferably have a nip width formed between itself and the collecting roller 62 in order to improve cleaning power by the web 61, and therefore a silicone sponge which has a heat-resistant property and which is, e.g., 30 mm in diameter is wound around the rotation shaft 63a. Further, this silicone sponge is coated with a FPA tube, for preventing deposition of the toner, having a thickness of, e.g., 100 μm.

At an upper portion of the roller supporting plate 90 in a side opposite from the unit rotation shaft 90a, the unit urging spring 96 supported at one end thereof by the casing 31 is supported at the other end thereof. At an upper-like portion of the fixing roller 40 in FIG. 3, an elliptical mounting-and-demounting cam 91 having an eccentric rotation shaft 91a which is one of two focuses is disposed so as to be substantially at the same level as the collecting roller 62 with respect to a horizontal direction. The roller supporting plate 90 urged in an arrow G direction by the unit urging spring 96 effects contact and separation (spacing) between the collecting roller 62 and the cleaning web 61 with the unit rotation shaft 90a as the fulcrum with rotation of the mounting-and-demounting cam 91 in a state in which a lower-left portion thereof is pressed against the mounting-and-demounting cam 91.

The rotation shaft 63a of the web roller 63 is rotatably and slidably supported by the elongated hole 90b. An extension direction of the elongated shaft 63a is a direction perpendicular to an extension direction (arrow I direction) of the nip between the web 61 (contacting the web roller 63) and the collecting roller 62.

The collecting roller 62 is supported by the casing 31 at end portions of the rotation shaft 62a by unshown ball bearings so that the collecting roller 62 is movable in advancing and retracting directions relative to the fixing roller 40. The collecting roller 62 is constituted so as to be pressed against the fixing roller 40, while the contact pressure thereof toward the fixing roller 40 is stepwisely switched, by the pressure switching mechanism 33 including the collecting roller urging spring 93, the collecting roller urging arm 94 and the collecting roller urging cam 95 (FIG. 4). The collecting roller cam 95 is constituted in an elliptical shape such that one of two focuses thereof is an eccentric rotation shaft 95a.

The collecting roller urging spring 93 consisting of a tension spring is supported at one end thereof by an end portion of the rotation shaft 62a of the collecting roller 62 and is supported at the other end thereof by a central portion of the collecting roller urging arm 94. By rotation of the collecting roller urging cam 95, the urging arm 94 swings about a rotation shaft 94a in an arrow O direction. By the swing, an operating length of the collecting roller urging spring 93 changes, so that the pressure of the collecting roller 62 applied to the fixing roller 40 is changed. A variable range of the pressure is set from 0 N to 80 N.

For example, in a state in which the toner is deposited in a large amount on the collecting roller 62, when the nip pressure between the fixing roller 40 and the collecting roller 62 is excessively high, there is a high possibility that the toner is transferred back to the fixing roller 40. For that reason, in the case where the toner is large in amount after generation of a jam or the like, the nip pressure between the collecting roller 62 and the fixing roller 40 may preferably be lowered to the possible extent. However, in order to prevent slip of the collecting roller 62, the contact pressure of the collecting roller 62 may preferably be determined so that a frictional force F2 (FIG. 2) between the web 61 and the collecting roller 62 is smaller than a frictional force F1 (FIG. 2) between the collecting roller 62 and the fixing roller 40.

Therefore, the nip pressure between the collecting roller 62 and the fixing roller 40 is lowered to the possible extent, so that the contact pressure is determined so as to satisfy F2<F1. In a state in which the cleaning web 61 is spaced from the collecting roller 62 (in the third position, i.e., in a separation (spacing) mode ((c) of FIG. 4)), a set value of the pressure of the collecting roller urging spring 93 is ON, so that a contact state of the collecting roller 62 with the fixing roller 40 is maintained only by the self-weight of the collecting roller 62.

The collecting roller 62 is rotated by rotation of the fixing roller 40 by transmitting a driving force from the fixing roller 40 to the collecting roller 62. In a state in which the web 61 is contacted to the collecting roller 62 by the web roller 63, when the fixing roller 40 is rotated, the toner collected from the fixing roller 40 onto the collecting roller 62 by rotation of the collect 62 rotated by the rotation of the fixing roller 40 is removed by the web 61. In that case, the web 61 contacting the collecting roller 62 is gradually wound up in the arrow B direction, so that a fresh (new) portion thereof contacts the collecting roller 62 before an associated portion of the web 61 is saturated with the toner.

Next, with reference to FIG. 5, a control system in this embodiment will be described. FIG. 5 is a block diagram showing the control system for effecting contact-and-separation control of the cleaning unit 60 in this embodiment.

That is, the printer 16 (FIG. 1) includes an entire system controller 200 for effecting integral control of the respective portions, and a controller 202 is connected with the entire system controller 200.

In the controller 202, a plurality of counters 204 are provided. To the controller 202, a cleaning unit controller 203, a remaining detecting sensor 205, a temperature sensor 42a, the fixing roller heater 40a and the fixing roller motor 211 are connected. Further, to the controller 202, an opposite roller temperature detecting sensor 42a, the opposite roller heater 41a, an opposite roller motor 213 and a collecting roller mounting-and-demounting motor 212 are connected.

The temperature of the collecting roller 62 follows the temperature of the fixing roller 40, and therefore, temperature control of the collecting roller 62 is made by temperature adjustment (temperature control) of the fixing roller 40. That is, the controller 202 controls the temperature of the collecting roller (rotatable cleaning member) 62 via the fixing roller 40 by controlling an operation of the heater 40a on the basis of an output of the temperature 42a.

To the unit controller 203 described above, a home position sensor 208 for detecting a home position of the web roller 63 relative to the collecting roller 62 and a web mounting-and-demounting motor 209 for mounting and demounting the web 61 relative to the collecting roller 62 by rotating the mounting-and-demounting cam 91 are connected. Further, to the unit controller 203, the web feeding motor 210 for winding up the web 61 by rotating the winding-up roller 65 is connected.

The controller 202 also functions as an executing portion for executing an operation in a cleaning mode in which the collecting roller 62 is cleaned at the second develop ((b) of FIG. 4) and the first position ((a) of FIG. 4) in the listed order. The controller 202 controls whether or not the in the cleaning mode should be started, on the basis of an output of the temperature sensor 42a.

The controller 202 effects the following control in accordance with an instruction from the entire system controller 200, on the basis of detection signals from the temperature sensor 42a and the opposite roller temperature detecting sensor 42b. That is, the controller 202 contacts not only the cleaning unit 60 via the cleaning unit controller 203 but also each of the fixing roller heater 40a, the fixing roller motor 211, the collecting roller mounting-and-demounting motor 212, the opposite roller heater 41a and the opposite roller motor 213.

The controller 202 is constituted so that the operation in the separation mode ((c) of FIG. 4) is executable via the cleaning unit controller 203. At the first position ((a) of FIG. 4), by controlling the pressure switching mechanism (pressure switching means) 33 and the contact-and-separation mechanism 32, the collecting roller 62 is contacted to the fixing roller (rotatable member) 40 at a high pressure (e.g., 45N). At the second position ((b) of FIG. 4), by controlling the pressure switching mechanism 33 and the contact-and-separation mechanism 32, the collecting roller 62 is contacted to the fixing roller 40 at a low pressure (e.g., 20N). At the third position (separated (spaced) position), by controlling the pressure switching mechanism 33 and the contact-and-separation mechanism 32, the web 61 is spaced from the collecting roller 62.

The controller 202 controls the temperature of the collecting roller 62 so that the temperature of the collecting roller 62 when the unit 60 is moved from the third position ((c) of FIG. 4) to the second position ((b) of FIG. 4) is higher than the temperature of the collecting roller 62 when the unit 60 is moved from the second position ((b) of FIG. 4) to the first position ((a) of FIG. 4). As a result, it is possible to suppress a phenomenon, such that the web 61 is unintentionally pulled out or that the toner is transferred back to the fixing roller 40, while improving a cleaning property.

The controller 202 controls the fixing roller heater 40a and starts a lowering in temperature of the collecting roller 62 from a temperature in a state in which the unit 60 is located in the second position. As a result, the temperature at the time of starting the cleaning at the first position can be made lower than the temperature at the time of starting the cleaning at the second position.

The cleaning unit controller 203 rotates the mounting-and-demounting cam 91 by driving the web mounting-and-demounting motor 209 while discriminating the position of the web roller 63 relative to the collecting roller 62 by the home position sensor 209. At the same time, the web 61 is mounted on and demounted from the collecting roller 62 while being wound up by drive of the web feeding motor 210.

The remaining detecting sensor 205 detects the recording material S remaining in the fixing device 9 during jam generation or the like, and then sends a detection signal of the recording material S to the controller 202.

The temperature sensor 42a detects the surface temperature of the fixing roller 40, and then sends its detection signal to the controller 202. A heat generation temperature of the fixing roller heater 40a is adjusted by control by the controller 202, so that the surface temperature of the fixing roller 40 is adjusted, but constitutes a temperature adjusting means for adjusting the surface temperature of the collecting roller (cleaning member) 62 on the basis of the surface temperature of the fixing roller 40. The fixing roller motor 211 rotates the fixing roller 40 in the arrow K direction in FIG. 2 by the control by the controller 202.

The opposite roller temperature detecting sensor 42b detects the surface temperature of the opposite roller 41, and then sends its detection signal to the controller 202. A heat generation temperature of the opposite roller heater 31a is adjusted by the control by the controller 202, so that the opposite roller heater 41a adjusts the surface temperature of the opposite roller 41. The opposite roller motor 213 rotates the opposite roller 41 in the arrow L direction in FIG. 2 by the control by the controller 202.

The controller 202 rotates the collecting roller urging cam 95 by driving the collecting roller mounting-and-demounting motor 212 while discriminating the position of the collecting roller 62 relative to the fixing roller 40, so that the collecting roller 62 is contacted to and spaced from the fixing roller 40.

The cleaning during the jam generation is performed in the following manner in order to suppress a pulling-out phenomenon of the cleaning web 61 when the toner is deposited (closely) on the entire surface of the collecting roller 62 due to the jam generation.

That is, the collecting roller 62 does not include a heat source, and therefore the controller 202 increases a (temperature) control temperature of the fixing roller 40 up to 150° C., and thus increases the temperature of the collecting roller 62 up to 150° C., so that temperature adjustment of the collecting roller 62 is performed from the fixing roller 40 side.

Then, the cleaning web 61 is contacted to the collecting roller 62 at the low pressure (e.g., 20N) generated via the web roller 63, and the collecting roller 62 is contacted to the fixing roller 40 at the high pressure (e.g., 45N). From immediately after start of the cleaning, the control temperature of the fixing roller 40 is changed to, e.g., 140° C., so that the temperature of the collecting roller 62 is gradually lowered.

Then, after the cleaning is performed for a certain time at the high pressure (second pressure), the temperature of the collecting roller 62 is lowered to about 140° C. At this time, the contact pressure of the cleaning web 61 is increased to, e.g., 40N, and the contact pressure between the collecting roller 62 and the fixing roller 40 is increased to, e.g., 90N, so that it is possible to start finishing cleaning.

As described above, first, the cleaning is performed at the low pressure, and therefore even when the toner is deposited in a large amount on the collecting roller 62, the frictional force in the nip between the web 61 and the collecting roller 62 can be lowered by lowering normal reaction between the web 61 and the collecting roller 62. As a result, it is possible to prevent an inconvenience such that the web 61 is pulled out from the winding-up roller 65.

Then, the temperature of the collecting roller 62 at the time of starting the cleaning is set at a high temperature of, e.g., 150° C. at the second position, and is set at a low temperature of, e.g., 140° C. at the first position. This is because a viscosity of the toner is lowered compared with normal cleaning carried out at, e.g., about 140° C., and thus the frictional force exerted on the cleaning web 61 is alleviated. As a result, it is possible to improve a toner collecting property of the cleaning web 61 while more effectively suppressing a degree of the pulling-out of the cleaning web 61.

In this case, there is a liability that a transfer-back phenomenon of the toner onto the fixing roller 40 generates due to an increase in temperature. However, the transfer-back phenomenon is correlated with the pressure and the temperature, and therefore a margin again the transfer-back of the toner is broadened toward a high temperature direction by lowering the nip pressure between the collecting roller 62 and the fixing roller 40 from a normal pressure of 90N to 45N. For that reason, the transfer-back of the toner can be suppressed.

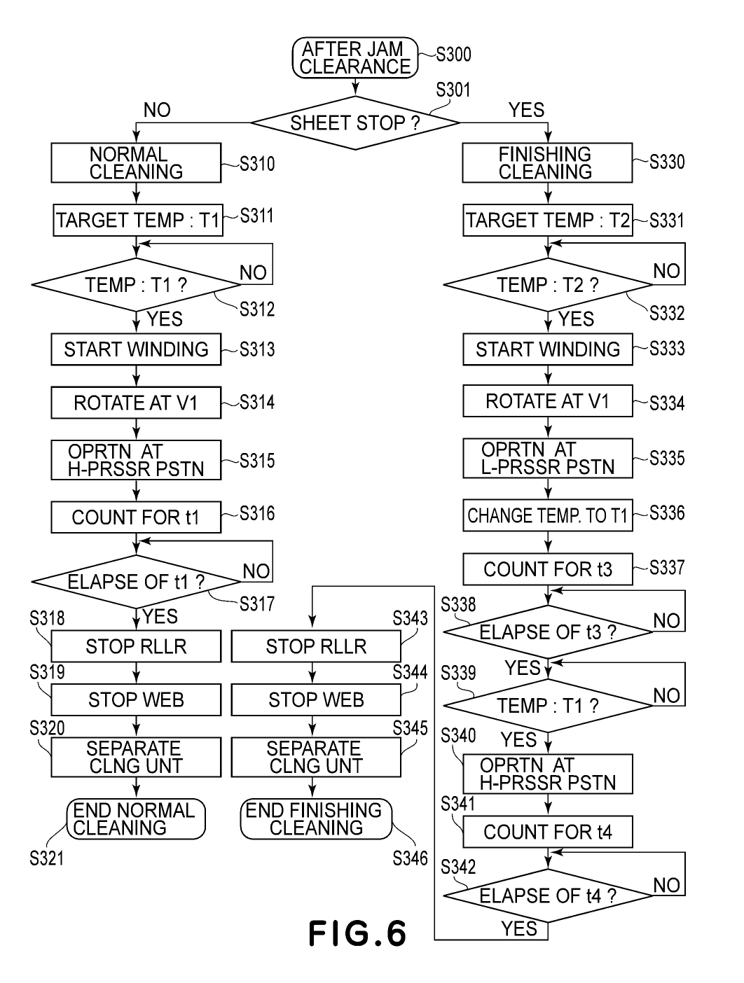

Next, the action (function) of this embodiment will be described with reference to FIGS. 4 and 6. FIG. 6 is a flowchart for illustrating a process of carrying out normal cleaning, low pressure cleaning and high pressure cleaning.

That is the controller 202 executed in accordance with an instruction from the entire system controller 200 detects, via the remaining detecting sensor 205, whether or not the recording material S exists in the fixing device 9 during the jam generation. That is, in the printer 16, the controller 202 discriminates that the jam generates when a sensor (not shown) does not detect the recording material S in a certain time set in advance, and then displays a message, to the effect that the jam generates on an unshown display portion, and after jam clearance by a user is executed, executes a sequence of recovering from the jam state. The cleaning unit controller 203 effects, during a recovery process of the sequence of recovering from the jam state after the jam clearance, control so that an operation in a cleaning mode starting from a step S330 is executed. After the execution of this operation in the cleaning mode, image formation by control by the entire system controller 200 is resumed.

In the case where absence of the recording material S in the fixing device becomes clear after jam clearance (S300) (“NO” of S301), normal cleaning is started (S310). In the normal cleaning, first, the controller 202 turns on the fixing roller heater 40a provided inside the fixing roller 40, and the temperature of the fixing roller 40 is increases so as to become a target temperature T1 (140° C.) while being measured by the temperature sensor 42a (S311). Then, when the surface temperature of the fixing roller 40 reaches the target temperature T1 (140° C.) (“YES” of S312), the controller 202 starts a web-up operation of winding-up the web 61 (S313). By drive of the web feeding motor 21, the winding-up end portion 61b of the web 61 is wound up about the winding-up roller 65 at a speed of 1.0 mm/sec. Subsequently, rotation of the fixing roller 40 is started at a speed V1 (e.g., 200 mm/sec) (S314), so that the collecting roller 62 is rotated by the rotation of the fixing roller 40. Therefore, the rotational speed of the collecting roller 62 equals to the speed V1 (200 mm/sec).

Thereafter, a mounting operation of mounting the cleaning unit 60 and a pressing operation of pressing the collecting roller 62 are started at a high pressure position, and the mounting-and-demounting cam 91 is rotated to a position where a nip pressure (N2) between the web roller 63 and the collecting roller 62 is 40N, so that the web 61 is contacted to the collecting roller 62 (S315). At the same time, the urging cam 95 is rotated so that a pressure N1 between the collecting roller 62 and the fixing roller 40 is 90N (S315). Hereinafter, this position is referred to as the high pressure position ((a) of FIG. 4). In this case, jammed paper (jammed recording material) is in a state in which the jammed paper does not exist in the fixing device (“NO” of S301), and therefore the amount of the toner on the collecting roller 62 is very small. Accordingly, even when the pressure of the collecting roller 62 is increased, the transfer-back of the toner onto the fixing roller 40 does not generate.

The controller 202 starts count of the cleaning for a certain time t1 (e.g., 40 sec) by a counter 204 (S316). Then, when the counter 204 reaches the certain time t1 (“YES” of S317), the rotation of the fixing roller 40 is stopped (S318), and then the web feeding motor 210 is stopped, and thus the winding-up of the web 61 is stopped (S319).

Thereafter, the controller 202 starts a separating (spacing) operation of separating (spacing) the cleaning unit 60 and a pressure-reducing operation of the collecting roller 62 (S320). Then, when the cleaning unit 60 reaches a separated (spaced) position and the collecting roller urging cam 95 reaches a position where the pressure of the collecting roller urging spring 92 for the collecting roller 62 is ON ((c) of FIG. 4), a normal cleaning flow is ended (S321).

On the other hand, during jam generation, in the case where the controller 202 discriminates, via the remaining detecting sensor 205, that the recording material S remains in the fixing device (“YES” of S301), the controller 202 starts low pressure and finishing cleaning (S330).

In the case where the jam generates in the fixing device due to improper separation of the recording material S or the like, the recording material S adheres to the fixing roller 40 or the collecting roller 62, so that the toner is deposited over the surface of the collecting roller 62 in some cases. After jam clearance (removal of the jammed (stagnated) recording material S by the user), when the collecting roller 62 is rotationally driven for cleaning the collecting roller 62 in a state of contact of the web 61 with the collecting roller 62 at a pressure of not less than a certain value, there is liability that the toner is transferred back in a large amount onto the fixing roller 40. Further, there is a possibility that the web 61 is pulled due to a viscoelastic property and an adhesive property of the toner deposited on the collecting roller 62, so that the web 61 is reversely rotated, and thus the web 61 is pulled out.

A one-way gear (not shown) for preventing reverse rotation is provided at the winding-up end portion 61b, and therefore a center shaft of the web-up end portion 61b is not rotated, but when the web 61 remains in a large amount in the web-up side, there is a possibility that the web 61 is pulled out while being tightly squeezed. When the winding-up side web 61 is pulled out, the web 61 becomes entangled with the collecting roller 62 or the fixing roller 40, so that there is a possibility that tearing of the web 61, breakage of the fixing roller 40 and breakage of the sensors and the respective members which contact the fixing roller 40 are caused to generate.

Therefore, by first cleaning the collecting roller 62 at the low pressure, the normal reaction between the web 61 and the collecting roller 62 is lowered even when the toner is deposited in the large amount on the collecting roller 62, so that the frictional force in the nip can be lowered, and thus it is possible to prevent the web 61 from being discharged (pulled out). That is, the cleaning unit controller 203 cleans, in the operation in the cleaning mode, the collecting roller 62 over a predetermined time in a state in which the web 61 is in the second position (S330), and thereafter moves the web 61 to the first position (S340).

Further, when the toner exists in the large amount on the collecting roller 62, when the nip pressure (N1) between the collecting roller 62 and the fixing roller 40 is equal to the pressure during the normal cleaning, there is a liability that the toner collected from the fixing roller 40 is transferred back onto the fixing roller 40. For that reason, a relationship between the frictional force F2 between the web 61 and the collecting roller 62 and the frictional force F1 between the collecting roller 62 and the fixing roller 40 is set to satisfy F2<F1, so that the nip pressure (N1) between the collecting roller 62 and the fixing roller 40 is made small to the possible extent. As a result, the margin against the transfer-back of the toner with respect to the temperature during the low pressure cleaning can be broadened.

First, the controller 202 turns on the fixing roller heater 40a in the fixing roller 40, and controls the turning-on of the fixing roller heater 40a, while measuring the surface temperature of the fixing roller 40 by the temperature detecting sensor 42a, so that the surface temperature is a target temperature T2 (e.g., 150° C.) (S331).

Then, in a step S332, the cleaning is started in the case where the fixing roller surface temperature is not less than the target temperature (predetermined temperature) T2 at the time such as immediately after passing of the thick paper. That is, the controller 202 starts the operation in the cleaning mode when the temperature of the collecting roller (rotatable cleaning member) 62 is not less than the predetermined temperature (T2). That is, when the temperature of the fixing roller 40 reaches the target temperature T2 (150° C.) (“YES” of S332), the controller 202 starts a web-up operation of winding-up the web 61 (S333). The controller 202 drives the web feeding motor 21, so that the winding-up end portion 61b of the web 61 is wound up about the winding-up roller 65 at a speed of, e.g., 1.0 mm/sec.

On the other hand, when the temperature of the fixing roller 40 is less than the target temperature T2, i.e., in the case where the temperature of the fixing roller 40 is less than the predetermined temperature (T2) after the jam clearance (“NO” of S332), the heater 40a is turned on, and the cleaning is not started until the temperature reaches the target temperature T2. In the case where the temperature of the collecting roller 62 is less than the predetermined temperature (T2), the cleaning unit controller 203 delays the start of the operation in the cleaning mode by keeping the web 61 at the third position ((c) of FIG. 4) until the temperature of the collecting roller 62 increases up to the predetermined temperature. In this way, in the case where the temperatures of the fixing roller 40 and the collecting roller 62 at the time of starting the cleaning are lower than the target temperatures, the operation in the cleaning mode can be started after these rollers are properly heated.

Subsequently, rotational drive of the fixing roller 40 is started at a speed V1 (e.g., 200 mm/sec) (S334), so that the collecting roller 62 is driven by the rotational drive of the fixing roller 40. Therefore, the rotational speed of the collecting roller 62 equals to the speed V1 (200 mm/sec).

Thereafter, the controller 202 starts a mounting operation of mounting the cleaning unit 60 and a pressing operation of pressing the collecting roller 62, and rotates the mounting-and-demounting cam 91 to a position where a nip pressure (N2) between the web roller 63 and the collecting roller 62 is, e.g., 20N, so that the web 61 is contacted to the collecting roller 62 (S335). At the same time, the urging cam 95 is rotated so that a pressure between the collecting roller 62 and the fixing roller 40 is, e.g., 45N (S335). Hereinafter, this position is referred to as the low pressure position ((b) of FIG. 4).

Then, when the cleaning unit 60 starts the mounting operation, the controller 202 switches the target temperature T2 (e.g., 150° C.) of the fixing roller 40 to the target temperature T1 (e.g., 140° C.) (S336). At the same time, the controller 202 carries out the cleaning for a certain time t3 (e.g., 20 sec) counted by the counter 204 (S337).

Then, when the counter 204 reaches the certain time t3 (“YES” of 5338) and the surface temperature of the fixing roller 40 reaches the target temperature T1 (140° C.) (“YES” of S339), the cleaning unit 60 is moved as follows. That is, the cleaning unit 60 is moved to the high pressure position ((a) of FIG. 4) where the nip pressure (N2) between the web roller 63 and the collecting roller 62 is, e.g., 40N and the nip pressure (N1) between the collecting roller 62 and the fixing roller 40 is, e.g., 90N (S340), and then finishing cleaning is started. In the operation in the cleaning mode during execution, when the web 61 cleans the collecting roller 62 at the first position ((a) of FIG. 4), the controller 202 maintains the temperature of the collecting roller 62 at the target temperature T1 which is less than the predetermined temperature (T2).

In a low pressure state, when the cleaning is made to some extent, the toner, in a very small amount, which cannot be completely removed at the low pressure remains on the surface of the collecting roller 62. In order to clean the surface of the collecting roller 62, after the cleaning for the certain time at the low pressure, the contact pressure is increased and the finishing cleaning is carried out for a certain time, so that the residual toner is properly removed.

Further, when the collecting roller 62 is kept at the low pressure position, there is a liability that the collecting roller 62 slips with the fixing roller 40, and therefore when the contact pressure of the web 61 is increased, also the contact pressure (N1) between the collecting roller 62 and the fixing roller 40 is increased correspondingly. In the case where the contact pressure is increased in this way, there is a liability of generation of the transfer-back of the toner unless the temperature of the collecting roller 62 is lowered. Accordingly, the controller 202 controls the fixing roller heater 40a, and starts a lowering of the surface temperature of the collecting roller 62 from the execution of the operation in the cleaning mode.

That is, in the case where the target temperature of the fixing roller 40 is lowered, when the target temperature of the fixing roller 40 is changed after the low pressure cleaning is ended, this change takes much time. Accordingly, in order to save the time to reduce a downtime, by lowering the target temperature immediately after the low pressure cleaning and then by gradually lowering the temperature, the temperature is caused to approach the target temperature at timing when the finishing cleaning is started.

The controller 202 carried out the cleaning for a certain time t4 (40 sec) by a counter 204 (S341), and then, when the counter 204 reaches the certain time t4 (“YES” of S342), the rotation of the fixing roller 40 is stopped (S343). Then, the web feeding motor 210 is stopped, and thus the winding-up of the web 61 is stopped (S344). Thereafter, the controller 202 starts a separating (spacing) operation of separating (spacing) the cleaning unit 60 and a pressure-reducing operation of the collecting roller 62 (S345). Then, at the time when the cleaning unit 60 reaches a separated (spaced) position and the collecting roller urging cam 95 reaches a position where the pressure of the collecting roller urging spring 92 for the collecting roller 62 is ON ((c) of FIG. 4), a low pressure and finishing cleaning flow is ended (S346).

As described above, according to this embodiment, while improving the cleaning property, by suppressing the pulling-out of the web 61 and the transfer-back phenomenon that the transfer is transferred back onto the fixing roller 40, and the like, it is possible to provide the fixing device 9 having a constitution capable of stably carrying out good image formation.

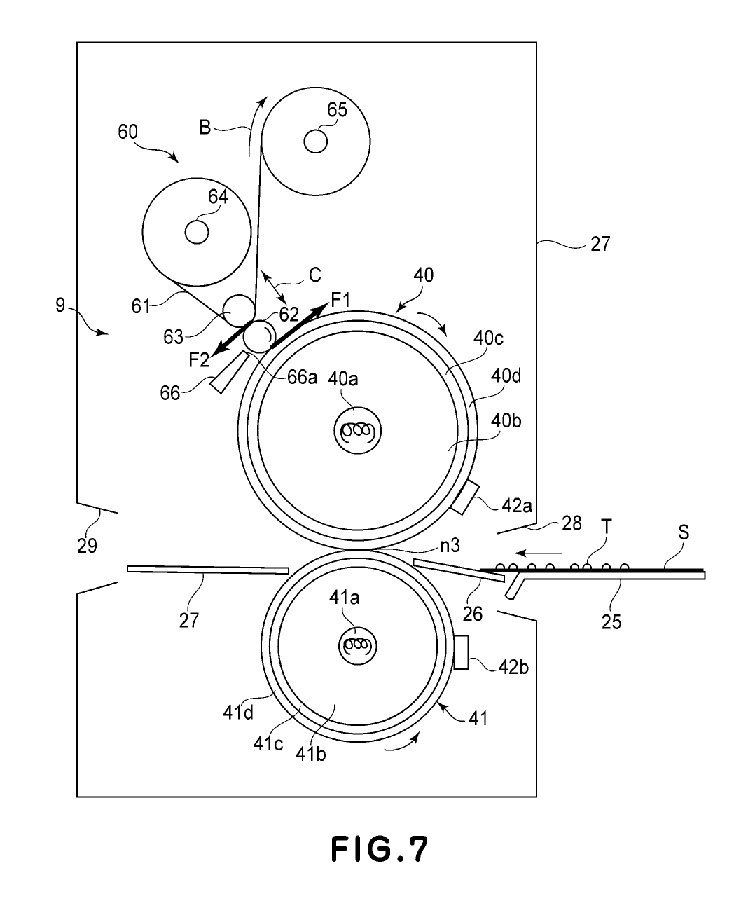

Next, with reference to FIG. 7, a modified embodiment will be described. In this modified embodiment, members identical to those in the above-described embodiment are represented by the same reference numerals or symbols, and constitutions and functions of the members are the same as those in the above-described embodiment will be omitted from description.

In the modified embodiment, as shown in FIG. 7, a blowing device 66 for blowing air toward the collecting roller 62 through a blowing port 66a is provided adjacently to the collecting roller 62. The blowing device 66 is controlled by the controller 202 so as to cool the collecting roller 62 thereby to lower the surface temperature. In the modified embodiment, the fixing roller heater 40a and the blowing device 66 perform the function of the temperature adjusting means.

Also in the modified embodiment employing the above constitution, not only an effect similar to the effect of the above-described embodiment but also the function as the temperature adjusting means can be further improved by enhancing a cooling effect for the collecting roller 62.

According to the embodiment and the modified embodiment, in order to prevent the transfer-back of the toner onto the fixing roller and the pulling-out of the web 61, in the cleaning during the jam generation, first, the temperature of the collecting roller 62 is set at the temperature higher than the normal cleaning temperature. Then, the web 61 is contacted to the collecting roller 62 at the low pressure, and then the collecting roller 62 is rotated. Then, when the cleaning is started, the set control temperature is lowered, and then the cleaning is performed for a certain time. Thereafter, the contact pressure is further increased in a state in which the temperature of the collecting roller 62 is lowered to the normal temperature, and then the finishing cleaning is performed.

First, by first cleaning the collecting roller 62 at the low pressure, the normal reaction between the web 61 and the collecting roller 62 is lowered even when the toner is deposited in the large amount on the collecting roller 62, so that the frictional force in the nip can be lowered, and thus it is possible to prevent the web 61 from being discharged (pulled out). Further, the reason why the temperature is first state at the high temperature is that the collecting property of the toner onto the web 61 is improved while effectively suppressing the pulling-out of the web 61 by lowering the viscosity of the toner thereby to alleviate the frictional force exerted on the web 51. As described above, there is a liability that the transfer-back phenomenon of the toner onto the fixing roller 40 generates due to the increase of the temperature, but the transfer-back of the toner is correlated with the pressure and the temperature, and therefore the margin against the transfer-back of the toner is broadened toward the high-temperature direction by creating the low pressure state. For this reason, it is possible to suppress the transfer-back of the toner.

In the low pressure state, when the cleaning is made to some extent, the toner, in a very small amount, which cannot be completely removed at the low pressure remains on the surface of the collecting roller 62. In order to clean the surface of the collecting roller 62, after the cleaning for the certain time at the low pressure, the contact pressure is increased and the finishing cleaning is carried out for a certain time, so that the residual toner is properly removed. At this time, the contact pressure is increased, and therefore when the control temperature is kept at the high temperature, the transfer-back of the toner onto the fixing roller 40 generates, but in the finishing cleaning, the temperature of the collecting roller 62 is lowered, so that the margin against the transfer-back of the toner in an amount corresponding to the increase in contact pressure is supplemented by the lowering in temperature, and thus the transfer-back of the toner is suppressed.

As a result, after the jam, even when the collecting roller 62 is in a state in which the toner is deposited over the surface thereof, it is possible to prevent the discharge (pulling-out) of the web 61 while suppressing the transfer-back of the toner onto the fixing roller 40. Further, breakage of the respective members such as the fixing roller 40 can be prevented, and it is possible to properly clean the surface of the collecting roller 62.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 045861/2014 filed Mar. 10, 2014, which is hereby incorporated by reference.

What is claimed is:

1. An image heating apparatus comprising:
a rotatable heating member configured to heat a toner image on a recording material;
a rotatable collecting member configured to collect a toner deposited on said rotatable heating member;
a cleaning web configured to clean said rotatable collecting member;
an urging roller configured to urge said cleaning web toward said rotatable collecting member;
a moving mechanism configured to move said urging roller so as to be movable between a first position where said cleaning web contacts said rotatable collecting member, a second position where said cleaning web contacts said rotatable collecting member at a contact pressure lower than a contact pressure at the first position, and a third position where said cleaning web is spaced from said rotatable collecting member;
an executing portion configured to execute an operation in a cleaning mode in which said rotatable collecting member is cleaned at the second position and the first position in this order; and
a controller configured to control, in the operation in the cleaning mode, a temperature of said rotatable collecting roller so that the temperature when said urging roller is moved from the third position to the second position is higher than the temperature when said urging roller is moved from the second position to the first position.

2. An image heating apparatus according to claim 1, further comprising:
a detecting device configured to detect the temperature of said rotatable collecting member; and
a heating mechanism configured to heat said rotatable heating member,
wherein said controller controls an operation of said heating mechanism on the basis of an output of said detecting device in the operation in the cleaning mode.

3. An image heating apparatus according to claim 2, wherein in the operation in the cleaning mode, said controller stops the operation of said heating mechanism after said rotatable collecting member is cleaned for a predetermined time in a state in which said urging roller is in the second position and before said urging roller is moved from the second position to the first position.

4. An image heating apparatus according to claim 1, further comprising:
a roller about which said cleaning web is wound; and
a roller configured to wind up said cleaning web,
wherein said urging roller is provided between said two rollers with respect to a movement direction of said cleaning web.

5. An image heating apparatus according to claim 1, wherein said rotatable collecting member is a follower roller rotated by said rotatable heating member.

6. An image heating apparatus comprising:
a rotatable heating member configured to heat a toner image on a recording material;
a rotatable collecting member configured to collect a toner deposited on said rotatable heating member;
a cleaning web configured to clean said rotatable collecting member;
an urging roller configured to urge said cleaning web toward said rotatable collecting member;
a moving mechanism configured to move said urging roller so as to be movable between a first position where said cleaning web contacts said rotatable collecting member, a second position where said cleaning web contacts said rotatable collecting member at a contact pressure lower than a contact pressure at the first position, and a third position where said cleaning web is spaced from said rotatable collecting member;
an executing portion configured to execute an operation in a cleaning mode in which said rotatable collecting member is cleaned at the second position and the first position in this order; and
a controller configured to control a temperature of said rotatable collecting roller in the operation in the cleaning mode,
wherein in the operation in the cleaning mode, said moving mechanism moves said urging roller from the third position to the second position when the temperature is a first temperature, and moves said urging roller from the second position to the first position when the temperature is a second temperature lower than the first temperature.

7. An image heating apparatus according to claim 6, further comprising:
a detecting device configured to detect the temperature of said rotatable collecting member; and
a heating mechanism configured to heat said rotatable heating member,
wherein said controller controls an operation of said heating mechanism on the basis of an output of said detecting device in the operation in the cleaning mode.

8. An image heating apparatus according to claim 7, wherein in the operation in the cleaning mode, said controller stops the operation of said heating mechanism after said rotatable collecting member is cleaned for a predetermined time in a state in which said urging roller is in the second position and before said urging roller is moved from the second position to the first position.

9. An image heating apparatus according to claim 6, further comprising:
a roller about which said cleaning web is wound; and
a roller configured to wind up said cleaning web,
wherein said urging roller is provided between said two rollers with respect to a movement direction of said cleaning web.

10. An image heating apparatus according to claim 6, wherein in the operation in the cleaning mode, said controller maintains the temperature of said rotatable collecting member, in a period of a lapse of a predetermined time from movement of said urging roller from the third position to the second position, and a temperature of not less than the first temperature.

11. An image heating apparatus according to claim 6, wherein in the operation in the cleaning mode, said controller maintains the temperature of said rotatable collecting member at a temperature of not more than the second temperature after said urging roller is moved from the second position to the first position.

12. An image heating apparatus according to claim 6, wherein said rotatable collecting member is a follower roller rotated by said rotatable heating member.

13. An image heating apparatus comprising:
a rotatable heating member configured to heat a toner image on a recording material;
a rotatable collecting member configured to collect a toner deposited on said rotatable heating member;
a cleaning web configured to clean said rotatable collecting member;
an urging roller configured to urge said cleaning web toward said rotatable collecting member;
a moving mechanism configured to move said urging roller so as to be movable between a first position where said cleaning web contacts said rotatable collecting member, a second position where said cleaning web contacts said rotatable collecting member at a contact pressure lower than a contact pressure at the first position, and a third position where said cleaning web is spaced from said rotatable collecting member;
an executing portion configured to execute an operation in a cleaning mode in which said rotatable collecting member is cleaned at the second position and the first position in this order; and
a controller configured to move said cleaning web from the first position to the third position with generation of a jam and configured to start a cleaning process after jam clearance by moving said cleaning web from the third position to the second position when a temperature of said rotatable collecting member is not less than a predetermined temperature.

14. An image heating apparatus according to claim 13, wherein said controller maintains the temperature of said rotatable collecting member at a temperature of not less than the predetermined temperature in a period from start of the cleaning process to a lapse of a predetermined time.

15. An image heating apparatus according to claim 14, wherein during the cleaning process, said controller moves said urging roller from the second position to the first position after the temperature of said rotatable collecting member is lowered to a temperature lower than the predetermined temperature.

16. An image heating apparatus according to claim 15, wherein during the cleaning process, said controller maintains the temperature of said rotatable collecting member at a temperature of not more than the temperature lower than the predetermined temperature after the urging roller is moved from the second position to the first position.

17. An image heating apparatus according to claim 13, further comprising:
a detecting device configured to detect the temperature of said rotatable collecting member; and
a heating mechanism configured to heat said rotatable heating member,
wherein said controller controls an operation of said heating mechanism on the basis of an output of said detecting device in the operation in the cleaning mode.

18. An image heating apparatus according to claim 13, further comprising:
a roller about which said cleaning web is wound; and
a roller configured to wind up said cleaning web,
wherein said urging roller is provided between said two rollers with respect to a movement direction of said cleaning web.

19. An image heating apparatus according to claim 13, wherein said rotatable collecting member is a follower roller rotated by said rotatable heating member.
